(19) United States
(12) Patent Application Publication
(10) Pub. No.: US 2012/0228442 A1
(43) Pub. Date: Sep. 13, 2012

(54) PORTABLE MODULAR MONOPOLE TOWER FOUNDATION

(75) Inventor: Michael CLIFTON, Flagstaff, AZ (US)

(73) Assignee: AMERICAN RESOURCE & ENERGY, INC., ST. PAUL, MN (US)

(21) Appl. No.: 13/405,542

(22) Filed: Feb. 27, 2012

Related U.S. Application Data
(60) Provisional application No. 61/446,809, filed on Feb. 25, 2011.

(51) Int. Cl. F16M 13/00; F16M 11/00

(52) U.S. Cl. 248/163.1; 248/188.8

(57) ABSTRACT

A portable and modular foundation that can be utilized to support a monopole a central hub and a plurality of legs. A proximal end of each leg is removably attached to the central hub. A mounting bracket is removably attached to a distal end of each leg and connecting members are removably secured to adjacent mounting brackets to form a perimeter around the hub. The connecting members are configured to receive ballast or other stabilizing mechanisms to stabilize the foundation to allow the monopole and the attached equipment to be raised and lowered. The present invention also includes a lifting mechanism that attaches to both the modular portable foundation and the monopole to raise and lower the monopole and the attached equipment.

### CROSS REFERENCE TO RELATED APPLICATION(S)

The present application claims the benefit of U.S. Provisional Patent Application Ser. No. 61/446,809 that was filed on Feb. 25, 2011, the contents of which are incorporated by reference in its entirety.

### FIELD OF THE DISCLOSURE

The present invention relates to a foundation and raising system for a monopole tower. More particularly, the present invention relates to a portable, modular foundation and raising system that can be stored and transported in a compact, disassembled state and assembled on site. The monopole tower is capable of supporting one of a number of pieces of equipment including, but not limited to, wind turbines, solar panels, street lights, communication devices and monitoring systems.

### BACKGROUND

Monopoles towers are becoming increasingly utilized in numerous industries including, for instance, renewable wind energy and solar energy and also in the satellite and wireless communication industries. Monopole towers provide the necessary structural support to maintain a wind turbine including up 10 kW turbines, solar panels or antennae in an elevated position while reducing capital expenditures necessary for a typical support structure. Monopoles can also be utilized to support meteorological equipment such as an anemometer, wind direction vanes, temperature sensors and pressure sensors. Monopoles can also be utilized to support street lights or any other industry where an elevated lighting source can be utilized, such as the construction industry.

Typically, monopoles are secured to concrete foundations having footings buried into the ground. Concrete foundations are typically expensive to construct and often times require a construction permit. Once constructed, the foundation cannot be moved. Therefore, if a location for a monopole is abandoned or becomes obsolete, the foundation is either removed or abandoned at the location. In the event that the location is abandoned, the foundation can become a potential hazard.

Further, typical monopole foundations do not provide the capability to raise and lower the monopole and the attached equipment. Having the capability to easily raise and lower the monopole allows access to the equipment at ground level to repair or maintain the equipment. The capability to raise and lower the monopole also allows the owner or operator to protect the equipment secured to the top of a monopole from damage during violent weather. For instance, if a wind turbine secured to a top of a monopole when left raised in the vertical position during a storm having high wind loads, then the wind turbine or the monopole or both could be damaged.

### SUMMARY

The present disclosure includes a portable and modular foundation that can be utilized to support a monopole. The foundation includes a central hub and a plurality of legs. A proximal end of each leg is removably attached to the central hub. A mounting bracket is removably attached to a distal end of each leg and connecting members are removably secured to adjacent mounting brackets to form a perimeter around the hub. The connecting members are configured to receive ballast or other stabilizing mechanisms to stabilize the foundation to allow the monopole and the attached equipment to be raised and lowered. The present invention also includes a lifting mechanism that attaches to both the modular portable foundation and the monopole to raise and lower the monopole and the attached equipment.

### BRIEF DESCRIPTION OF THE DRAWINGS

FIG. 1 is a perspective view of a portable and modular monopole foundation.

FIG. 2 is a side view of the foundation.

FIG. 3 is a top view of the foundation.

FIG. 4 is a bottom view of the foundation.

FIG. 5 is a partial perspective view of a leg of the foundation.

FIG. 6 is a perspective view of a portable and modular monopole foundation with ballast and a monopole attached thereto.

FIG. 7 is a partial view of a rig attached to the foundation.

FIG. 8 is a partial view of the rig secured with cables to the foundation.

FIG. 9 is a partial perspective view of the modular monopole foundation with a screw jack.

FIG. 10 is a partial perspective view of the modular monopole foundation with a hydraulic ram.

FIG. 11 is a perspective view of another modular monopole foundation.

### DETAILED DESCRIPTION

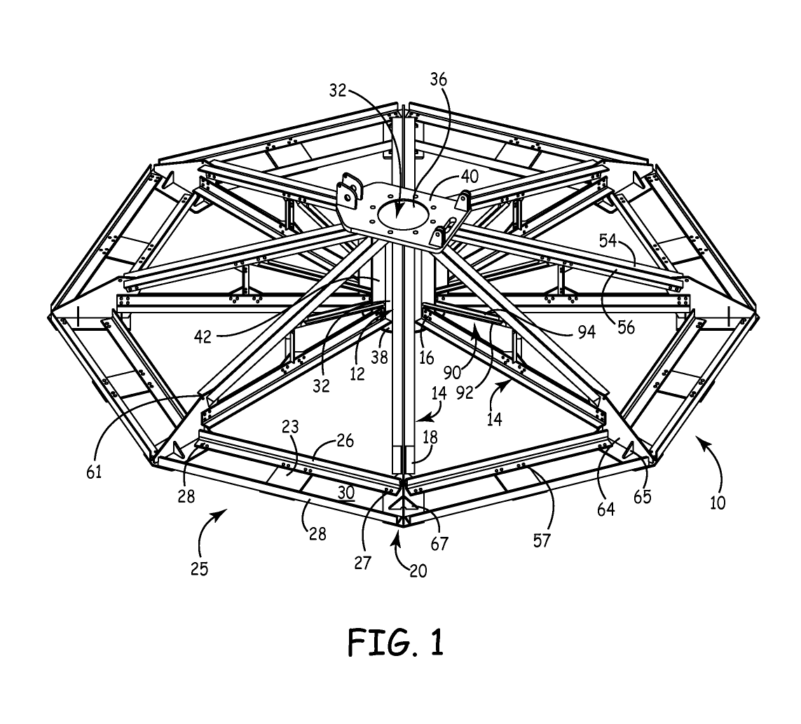

A portable and modular foundation is generally illustrated in FIG. 1 at 10. The foundation 10 includes a central hub 12 and a plurality of spaced apart legs 14 that are removably attached to the hub portion 12 at a proximal end 16. A mounting bracket 20 is removably attached to a distal end 18 of each of the plurality of spaced apart legs 14. A connecting member 25 is removably attached to adjacent mounting brackets 20 wherein the connecting members 25 form a perimeter with an annular channel 30 about the hub portion 12. The continuous annular channel 30 receives ballast to provide a sufficient stability to the foundation 10 such that a device attached a monopole is retained in an elevated position. Alternatively, earth anchors can be driven into the ground to secure the foundation in the selected location. Earth anchors can be purchased from American Earth Anchors, Inc. located in Franklin, Mass.

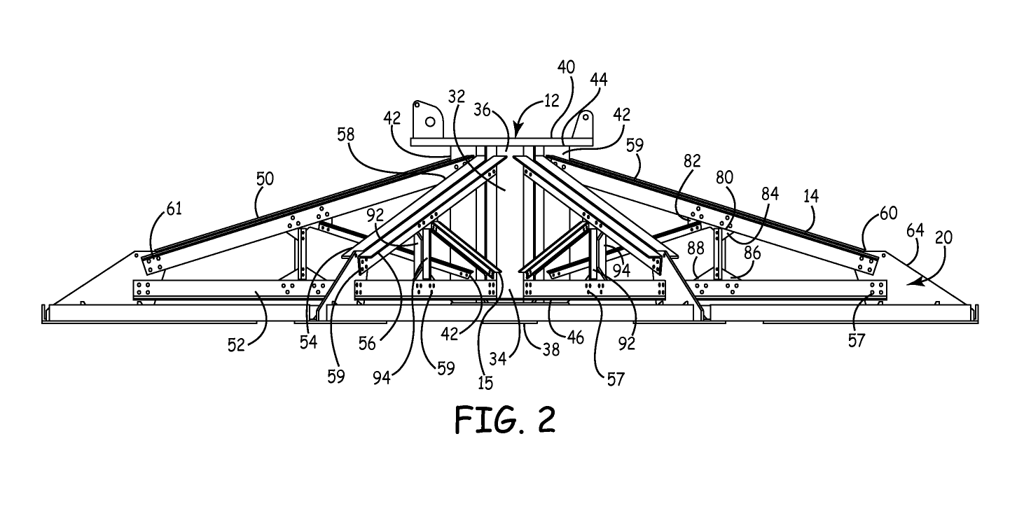

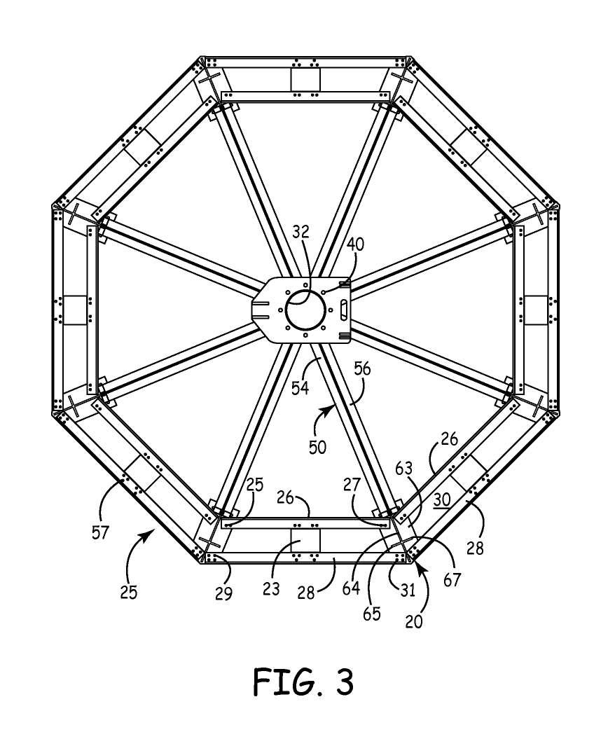

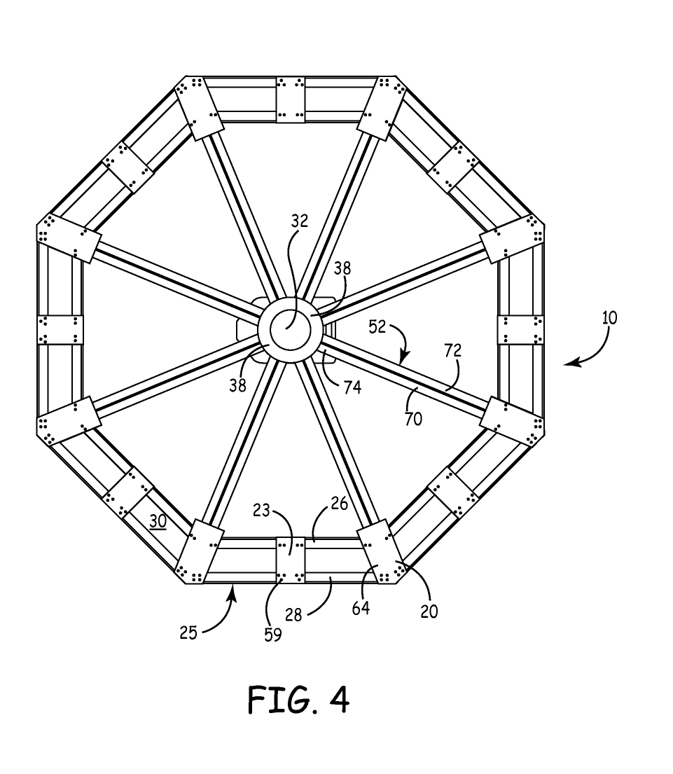

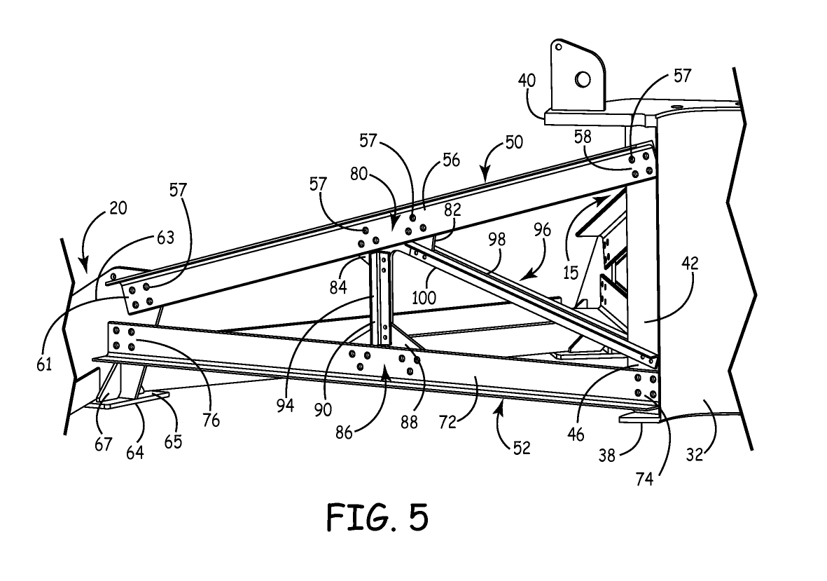

Referring to FIGS. 1-6, the foundation 10 can be stored and transported in a disassembled, compact state to a location where a monopole and associated equipment is desired. Each leg 14 and connecting member 25 includes a plurality of components that can be assembled using bolts 57 and nuts 59 at the site thereby allowing the foundation 10 to be assembled utilizing typically available tools such as wrenches and sockets. Because the foundation 10 can be assembled on site, the disassembled foundation 10 can be transported to remote locations in the compact, disassembled state where angle iron components can be nested one on top of the other relative to a foundation that is pre-assembled. Additionally, if the location of the foundation 10 and monopole with the equipment becomes undesirable, the monopole and the associated equipment can be lowered and removed from the foundation 10 and the foundation 10 can be disassembled for transport from the site by removing the nuts from the bolts.

The central hub 12 includes a pipe 32 having a lower end 34 and an upper end 36. A lower plate 38 is attached to the lower end 34 to provide support for the plurality of spaced apart legs 14. An upper plate 40 is attached to the upper end 36 of the pipe 32 where the upper plate 40 provides support for the monopole and the lifting mechanism for the monopole.

A plurality of spaced apart ribs 42 are attached to an outer surface 33 of the pipe 32 at substantially even intervals parallel with a longitudinal axis of the pipe 32. A top end 44 of each rib 42 is attached to the upper plate 40 and a bottom end 46 of each rib 42 is attached to the lower plate 38 to provide rigidity to the plurality of ribs 42.

The lower plate 38, the upper plate 40 and the plurality of spaced apart ribs 42 typically permanently attached to each other, typically with a weld. However a modular construction of the central hub 12 is also contemplated.

The proximal end 15 of each leg 14 is attached to a rib 42. Each of the plurality of legs 14 has the same or similar construction and therefore only one leg 14 will be described in detail. Each of the legs 14 has a modular design where the individual components of the legs 14 can be assembled and disassembled on site.

Each leg 14 includes a top beam 50 and a bottom beam 52. The top beam 50 includes left and right L shaped angle irons 54 and 56 where the flat surface of the angle irons 54 and 56 are positioned adjacent each other and also form a substantially flat top surface. The left and right angle irons 54 and 56 are positioned on opposite sides of the rib 42. Apertures located proximate a proximal end 58 in the left and right angle irons 54 and 56 align with apertures in the rib 42 such that bolts 57 can be positioned therethrough and secured with a threaded engagement with nuts 59. While bolts and nuts 59 are contemplated to secure the components together securing mechanisms, other securing mechanisms are also contemplated that allow for the legs to be assembled and disassembled on site.

Distal ends 61 of the left and right angle irons 54 and 56 are positioned on opposites sides of a vertical plate 64 of a mounting bracket 20 such that apertures located proximate a distal end 60 of the angle irons 54 and 56 are aligned with apertures in the plate 64. Bolts 57 are inserted therethrough and nuts 59 threadably engage the bolts 57 to secure the distal end 60 to the plate 64. The top beam 50 has a slanted configuration wherein the proximal end 58 is elevated relative to the distal end 61.

The bottom beam 52 includes a similar construction to that of the top beam 50 in that the bottom beam 52 includes left and right angle irons 70 and 72 that are positioned together such that vertical flat surfaces are adjacent each other and also form a substantially flat bottom surface. A proximal end 74 of the left and right angle irons 70 and 72 are attached to the bottom end 46 of the rib 42 utilizing aligned apertures and removably securable bolts 57 and nuts 59. A distal end 76 of the left and right angle irons 70 and 72 is also secured to the vertical plate 64 of the mounting bracket 26 by inserting bolts 57 through aligned apertures and securing the bolts 57 therein with nuts 59.

An intermediate top mounting plate 80 is positioned between the proximal end 59 and the distal end 61 of the left and right angle irons 54 and 56 and secured between the vertical surface of the angle irons 54 and 56 within bolts 57 inserted through aligned aperture and secured into position with a threaded engagement with nuts 59. The intermediate top mounting plate 80 includes front and back portions 82 and 84, respectively, that extend below the bottom edge of the angle iron 54 and 56.

An intermediate bottom mounting plate 86 is also secured between the vertical surfaces of the left and right angle irons 70 and 72. The intermediate bottom mounting plate 86 also includes a portion 88 that extends above a top surface of the bottom beam 52.

An intermediate vertical brace 90 having left and right angle irons 92 and 94 is positioned on opposite sides of the portion 88 of the bottom mounting plate 86 and the back portion 84 of the top mounting plate 80 and secured thereto with bolt 57 positioned through aligned apertures with nuts 59. The intermediate vertical brace 90 provides rigidity and structural integrity to the leg 14.

An upwardly slanted brace 96 having left and right angle irons 98 and 100 is secured to the rib 42 and also to the front portion 82 of the intermediate top mounting plate 80 with bolts 57 positioned through aligned apertures and secured therein with a threaded engagement with a nut 59. The upwardly slanted brace 96 provides further structural integrity and rigidity to the leg 14.

The mount bracket 20 is includes a bottom plate 63 which is attached to the vertical plate 64 such that a bottom surface of the bottom plate 63 engages the ground and the mounting bracket 62 and the vertical plate 64 is substantially perpendicular to the bottom plate 63. The mounting bracket 26 includes spaced apart left and right gussets 65 and 67 which provide support to the vertical plate 64 and prevent the vertical plate 64 from bending relative to the bottom plate 63. The components of the mounting bracket 62 are typically fixedly secured together, typically with a weld.

Each mounting bracket 20 is similarly constructed and the mounting brackets 20 are connected together with the connecting members 25 having inner and outer angle irons 26 and 28, respectively. The ends 25 and 27 of the inner angle iron 26 is attached to the bottom plate 63 of adjacent mounting brackets 20, typically with nuts 57 and bolts 59. The ends 29 and 31 of the outer angle iron 28 are also attached to the bottom plate 63 of the adjacent mounting brackets 62, typically with nuts and bolts.

Once constructed, the inner and outer angle irons 26 and 28 form the channel 30 around the perimeter of the foundation 10. The spacing between the angle irons 26 and 28 is maintained utilizing an intermediate brace 23 that is secured to both angle irons 26 and 28 between the respective ends. However, the intermediate brace 23 is secured to a bottom surface of the respective angle irons 26 and 28 so as to not interfere with placement of ballast within the channel.

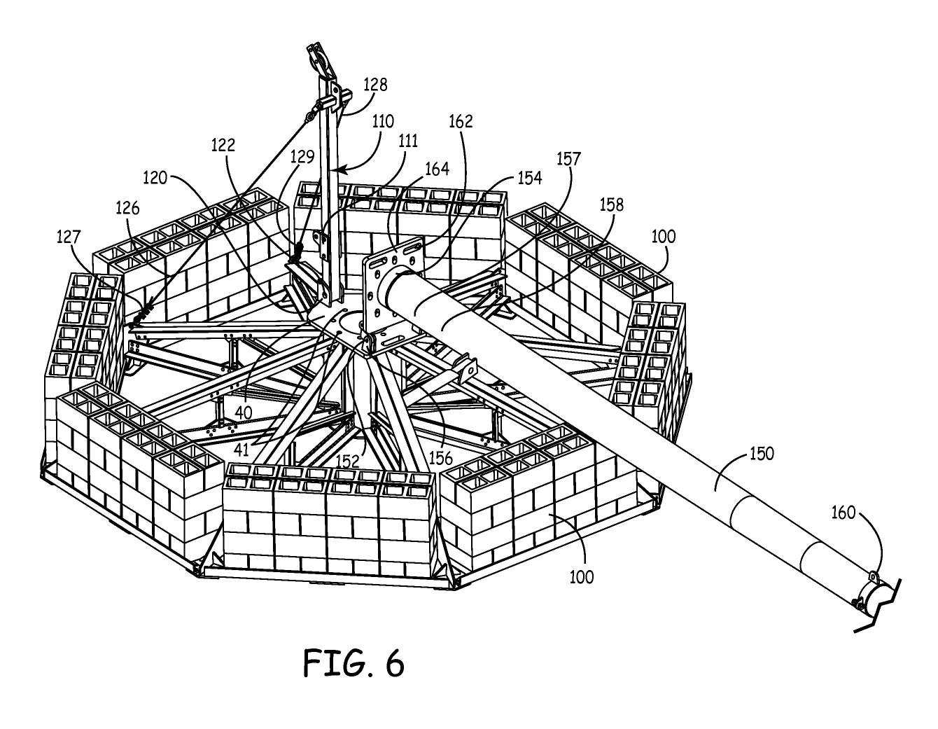

Referring to FIG. 6, ballast, such as concrete blocks 100, can be placed into the channel 30 around the perimeter of the foundation 10 where the bottom row of concrete blocks are retained within the channel 30 by the angle irons 26 and 28. Additional rows of concrete blocks 100 can be stacked one on top of another to provide the necessary ballast to provide the necessary stability to retain the monopole having a wind turbine, or other device, attached thereto.

If other ballast is desired to be utilized such as dirt, gravel or sand, the angle irons 26 and 28 can be replaced with baskets or buckets that will retain the free flowing material. However, the basket or buckets are also typically constructed in modular form to aid in transport of the foundation to and from a selected site. An alternative to ballast includes earth anchors.

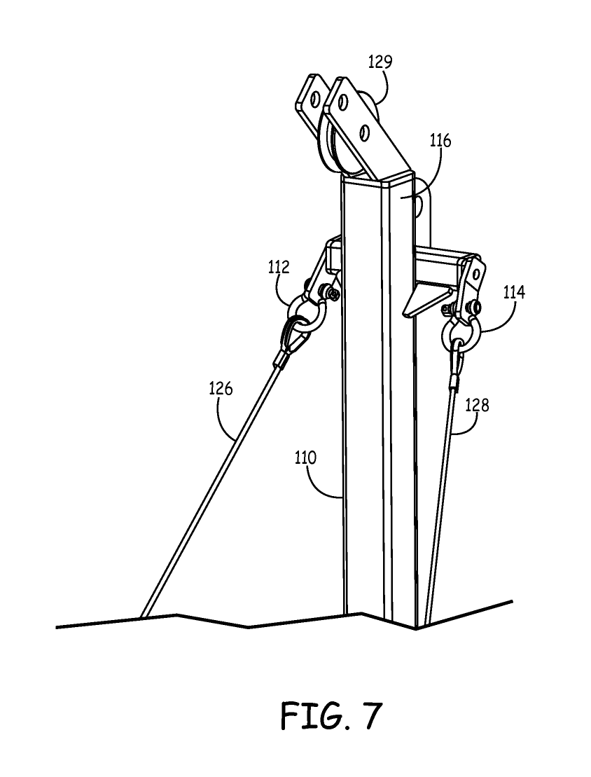

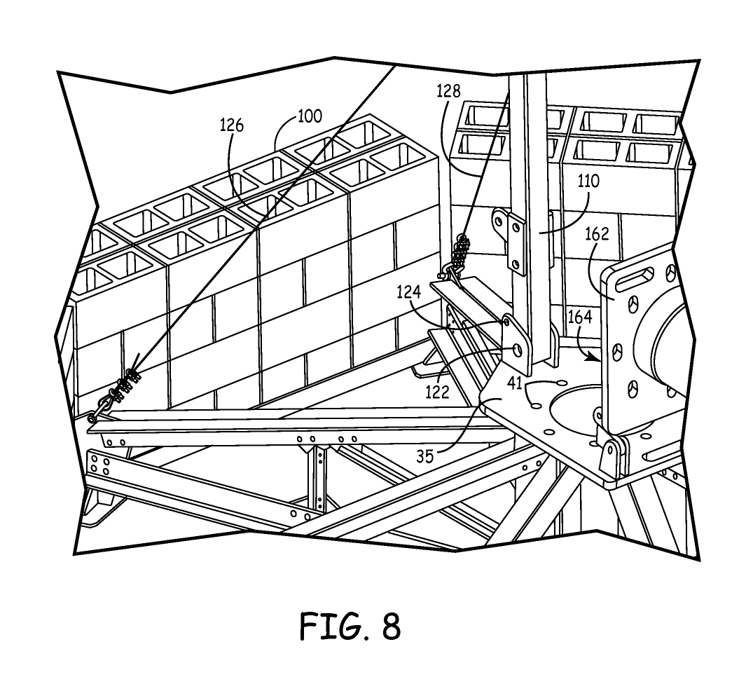

Referring to FIGS. 6-8, a rig 110 is pivotally attached to a mounting bracket 120 extending upwardly from the upper plate 40 with a pivot pin 122. A upper pin 124 is attached to the mounting bracket 120 and stops the pivotal movement of the rig 120 at a substantially vertical position. Left and right cables 126 and 128 are attached to the eye loops 112 and 114 that pivotally attached to the rig 110 proximate a top end 116. Distal ends 127, 129 of the cables 126, 128 are attached to the mounting brackets 62 such that the cables are placed into tension to retain the rig 110 in the substantially vertical position.

A monopole 150 is pivotally attached to the upper plate 150 with pivot pins 152 and 154 cooperating with left and right mounting brackets 154 and 156. A winch (not shown) is typically attached to the rig 110 at an intermediate mounting bracket 111 where the cable (not shown) is positioned around a pulley 129 attached to a top end of the rig 110. An end of the cable is secured through a mounting bracket 160 attached to the monopole 150 such that the winch can be utilized to raise and lower the monopole 150.

When the monopole 150 is raised to a substantially vertical position, apertures 164 in a mounting plate 162 that is attached to a bottom end 151 of the monopole 150 are aligned with apertures 41 in the upper plate 40 such that the mounting plate 162 is securable to the upper plate 62 with nuts and bolts or other removable securing members. The attachment and leveling of the monopole are described in U.S. patent application Ser. No. 13/177,145 the contents of which are incorporated by reference in its entirety.

The foundation 10 provides a compact modular design that can be easily transported and constructed on site. The foundation 10 has numerous securing features which allow the foundation 10 to be secured in several ways such that the foundation 10 can be utilized on almost any surface or terrain. Finally, the foundation 10 provides a safe, efficient and speedy mechanism for raising and lowering the monopole without the need of additional equipment or more than one person.

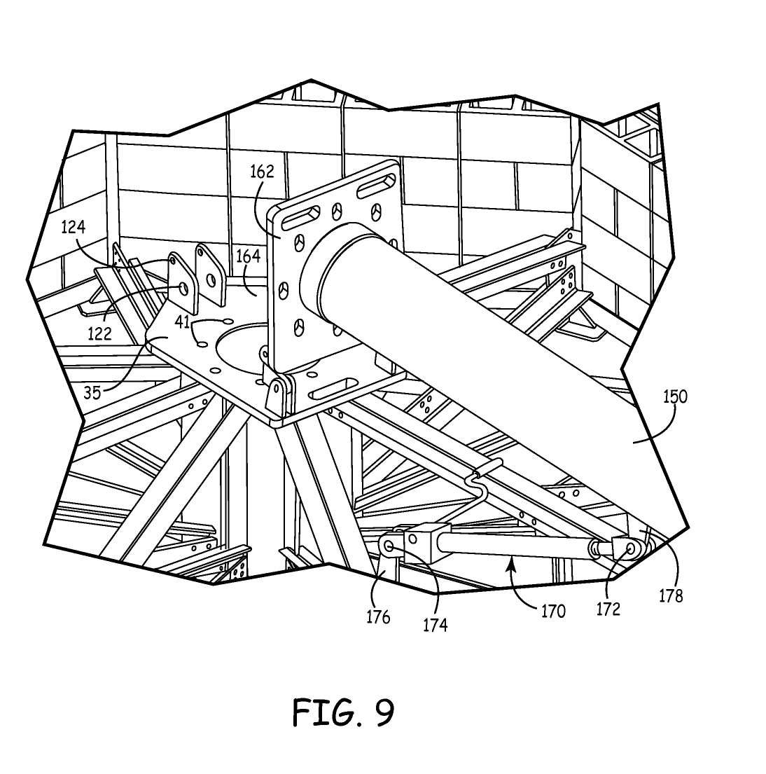

Referring to FIG. 9, the monopole 150 can be raised and lowered utilizing a screw jack 170. A distal end 172 of the screw jack 170 is pivotally attached to a mounting bracket 178 secured to the monopole 150. A proximal end 174 of the screw jack 170 is secured to a mounting bracket 176 that is attached to the foundation 10. Manipulation of the screw jack 170 causes the monopole 150 to be raised and lowered.

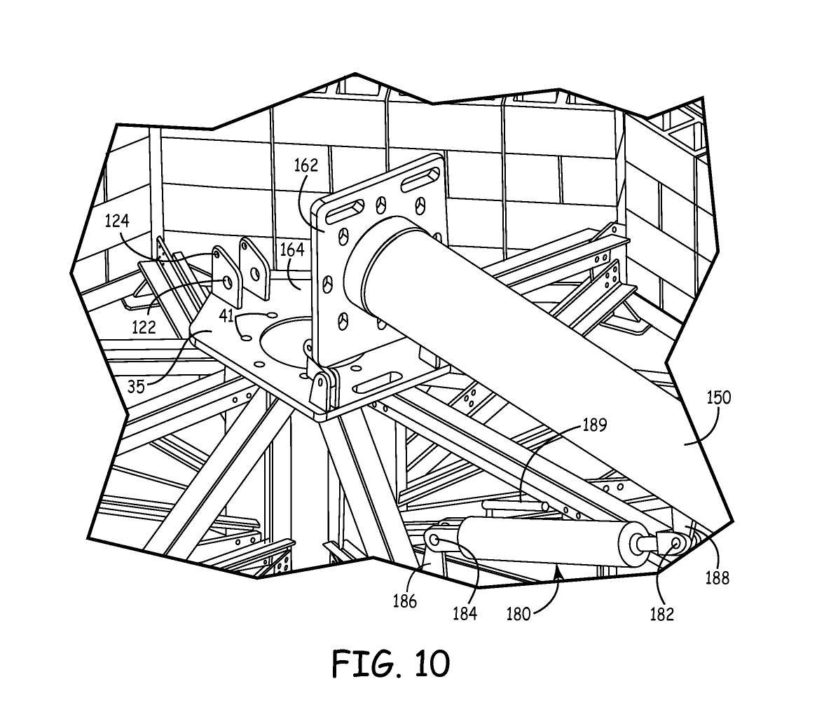

Referring to FIG. 10 the monopole 150 can be raised and lowered utilizing a hydraulic ram 180. A distal end 182 of the hydraulic ram 180 is pivotally attached to a mounting bracket 188 secured to the monopole 150. A proximal end 174 of the hydraulic ram 180 is secured to a mounting bracket 176 secured to the foundation 10. Manipulation of the hydraulic ram 180 with the handle 189 causes the monopole 150 to be raised and lowered.

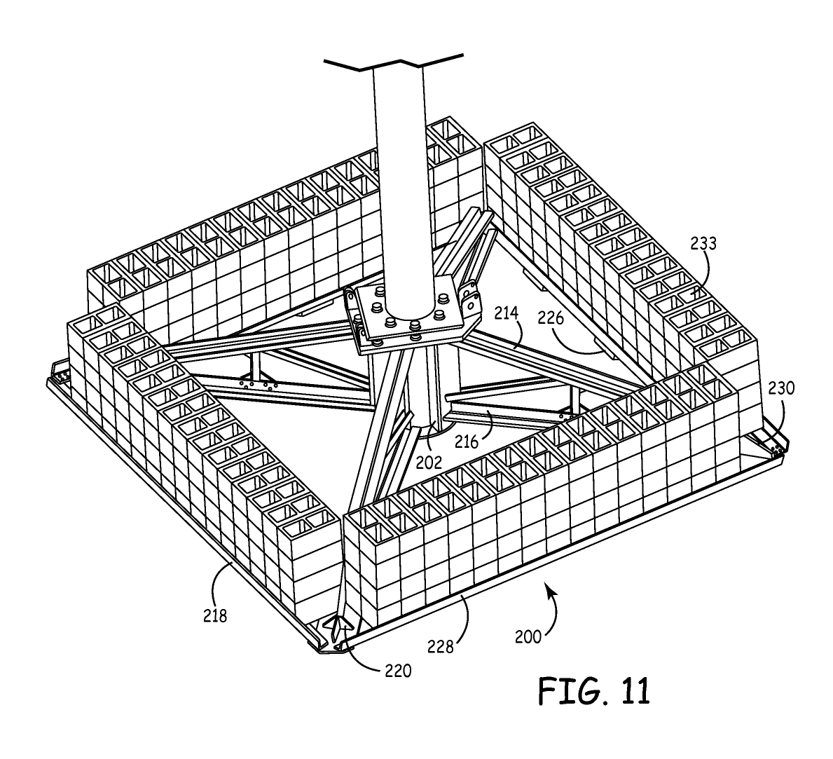

Referring to FIG. 11, another modular foundation is illustrated at 200. The modular foundation 200 is similar to the foundation 10 and includes a central hub portion 202 to which four spaced apart legs 214 are attached at a proximal end 216. A distal end 218 of each of the plurality of spaced apart legs 214 is attached to a mounting bracket 220 where the mounting bracket attaches to inner and outer L shaped members 226 and 228 at both a left edge 222 and a right edge 224 such that a continuous annular channel 230 is formed about a perimeter of the foundation 10. The continuous annular channel 230 receives ballast 232 to provide a sufficient stability to the foundation 210 such that a device attached to the foundation and a monopole is retained in an elevated position.

The legs 214 have the same construction as the legs 14 where the only significant difference in between the foundation 10 and the foundation 200 is the number of legs 14 and 214 where the foundation 214 has eight legs and the foundation 200 has four legs. It is contemplated that a foundation having three or more legs can be utilized to allow for the desired support depending upon the type of device being elevated by the monopole.

The present disclosure, while illustrating four and eight legs, can be utilized with three or more legs such that a continuous perimeter about the legs is formed. However, the closer the channel 30 resembles a circle, the more evenly the force is distributed about the hub.

Although the present invention has been described with reference to preferred embodiments, workers skilled in the art will recognize that changes may be made in form and detail without departing from the spirit and scope of the invention.

1. A foundation for a monopole comprising:
a central hub;
a plurality of legs removably attached to the hub at a proximal end thereof and having a distal end;
a plurality of mounting brackets, each mounting bracket removably attached to the distal end of each of the plurality of legs; and
a plurality of connecting members removably attached to adjacent mounting brackets, wherein the plurality of mounting brackets form a perimeter structure configured to receive ballast for stabilizing a raised monopole.

2. The foundation of claim 1 and wherein the hub further comprises:
a section of pipe having an outer surface, a first end, a second end and a central axis passing through the first end and the second end; and
a plurality of ribs attached to the pipe at substantially even intervals about the outer surface of the pipe and wherein the proximal end of each of the plurality of legs is configured to be removably attached to a rib.

3. The foundation of claim 2 and wherein the hub further comprises:
an upper plate attached to the first end of the pipe wherein the upper plate is attached to each of the plurality of ribs; and
a lower plate attached to the second end of the pipe wherein the lower plate is attached to each of the plurality of rib.

4. The foundation of claim 1 and wherein each of the plurality of legs comprises:
a top beam having a proximal end and a distal end wherein the proximal end is removably attached to one of the ribs and the distal end is removably attached to one of the mounting brackets; and
a bottom beam spaced apart from the top beam and wherein the bottom beam comprises a proximal end and a distal end wherein the proximal end is removably attached to one of the ribs and the distal end is removably attached to one of the mounting brackets such that the legs can be assembled at a selected location.

5. The foundation of claim 4 and wherein each of the plurality of legs further comprises an intermediate brace removably connected to both the top beam and the bottom beam between the proximal and distal ends of both the bottom beam and the top beam.

6. The foundation of claim 1 and wherein each mounting bracket comprises:
a bottom plate; and
a connecting plate attached to the bottom plate and wherein the distal end each leg is removably attached to the connecting plate.

7. The foundation of claim 6 and wherein each of the plurality of connecting members are removably attached to adjacent bottom plates of the mounting brackets.

8. The foundation of claim 7 and wherein the plurality of connecting members comprises spaced apart and substantially parallel members that form a channel about the hub.

9. The foundation of claim 8 and wherein the plurality of connecting members comprises an intermediate brace attached to the spaced apart and substantially parallel members.

10. The foundation of claim 1 and wherein the foundation comprises eight legs, eight mounting brackets and eight connecting members.

11. A monopole structure comprising:
a monopole having a proximal end for attaching to a foundation and a distal end for attaching a piece of equipment thereto;
a foundation comprising:
a central hub wherein the monopole pivotally attaches thereto;
a plurality of legs removably attached to the hub at a proximal end thereof and having a distal end;
a plurality of mounting brackets, each mounting bracket removably attached to the distal end of each of the plurality of legs; and
a plurality of connecting members removably attached to adjacent mounting brackets, wherein the plurality of mounting brackets form a perimeter structure configured to receive ballast for stabilizing a raised monopole; and
a lifting mechanism attached to the foundation and the monopole for raising and lowering the monopole.

12. The foundation of claim 11 and wherein the hub further comprises:
a section of pipe having an outer surface, a first end, a second end and a central axis passing through the first end and the second end; and
a plurality of ribs attached to the pipe at substantially even intervals about the outer surface of the pipe and wherein the proximal end of each of the plurality of legs is configured to be removably attached to a rib.

13. The foundation of claim 12 and wherein the hub further comprises:
an upper plate attached to the first end of the pipe wherein the upper plate is attached to each of the plurality of ribs; and
a lower plate attached to the second end of the pipe wherein the lower plate is attached to each of the plurality of rib.

14. The foundation of claim 11 and wherein each of the plurality of legs comprises:
a top beam having a proximal end and a distal end wherein the proximal end is removably attached to one of the ribs and the distal end is removably attached to one of the mounting brackets; and
a bottom beam spaced apart from the top beam and wherein the bottom beam comprises a proximal end and a distal end wherein the proximal end is removably attached to one of the ribs and the distal end is removably attached to one of the mounting brackets such that the legs can be assembled at a selected location.

15. The foundation of claim 14 and wherein each of the plurality of legs further comprises an intermediate brace removably connected to both the top beam and the bottom beam between the proximal and distal ends of both the bottom beam and the top beam.

16. The foundation of claim 11 and wherein each mounting bracket comprises:
a bottom plate; and
a connecting plate attached to the bottom plate and wherein the distal end each leg is removably attached to the connecting plate.

17. The foundation of claim 16 and wherein each of the plurality of connecting members is removably attached to adjacent bottom plates of the mounting brackets.

18. The foundation of claim 17 and wherein the plurality of connecting members comprises spaced apart and substantially parallel members that form a channel about the hub.

19. The foundation of claim 11 and wherein the lifting mechanism comprises a winch.

20. The foundation of claim 11 and wherein the lifting mechanism comprises a jack or a hydraulic ram.
